(19) United States
(12) Patent Application Publication
(10) Pub. No.: US 2005/0238979 A1
(43) Pub. Date: Oct. 27, 2005

(54) Compositions for application to the skin, to the lips, to the nails, and/or to hair

(76) Inventor: Christophe Dumousseaux, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/100,566

(22) Filed: Apr. 7, 2005

Related U.S. Application Data
(60) Provisional application No. 60/564,970, filed on Apr. 26, 2004.

(30) Foreign Application Priority Data
Apr. 8, 2004 (FR) 04 50713

(51) Int. Cl. G03G 9/00

(52) U.S. Cl. 430/106.2

(57) ABSTRACT

The present disclosure relates to a composition that has a covering power ranging from 25 to 100, for application to at least one of the skin, the lips, the nails, and hair, said composition comprising particles of at least one composite pigment, said particles comprising an inorganic core, which is at least partially coated with at least one organic coloring substance, and wherein the at least partially coated inorganic core is present in an amount sufficient for the saturation C* of the composition to range from 25 to 100.

This non provisional application claims the benefit of French Application No. 04 50713 filed on Apr. 8, 2004 and U.S. Provisional Application No. 60/564,970 filed on Apr. 26, 2004, the contents of both of which are incorporated herein by reference.

The present disclosure relates to cosmetic compositions for application to the skin, including the mucous membranes, for example, to the lips, to the nails, or to hair, such as the eyelashes, the eyebrows, and head hair.

Organic coloring substances are frequently used to give color to cosmetic compositions. But, with traditional organic coloring substances may not always be possible to obtain compositions that present satisfactory covering power. Moreover, in a cosmetic solvent, the shades contributed by those organic coloring substances may vary greatly between a dry state and a state in dispersion.

Thus, a need exists to have cosmetic compositions available that can present satisfactory saturation C* and sufficiently high covering power.

A need also exists for pigments that can present little color change depending on the surrounding environment.

Accordingly, the present disclosure relates to compositions that can have a covering power ranging from 25 to 100, for example, ranging from 25 to 90, such as ranging from 30 to 100, for example range from 30 to 90, said compositions being for application to the skin, to the lips, to the nails, and/or to hair, and wherein the compositions comprise particles of at least one composite pigment, said particles comprising:
an inorganic core at least partially coated with at least one organic coloring substance, wherein the at least partially coated inorganic core is present in an amount sufficient for the saturation C* of the composition to range from 25 to 100, for instance, from 30 to 100. Thus, according to the present disclosure, it is possible to obtain compositions that are both saturated and covering.

The at least one composite pigment can be present in the composition in an amount ranging from 0.1% to 30%, for instance, ranging from 0.1% to 20%, for example ranging from 0.1% to 15%, such as ranging from 0.3% to 10%, for example ranging from 1% to 5% by weight, relative to the total weight of the composition.

For instance, a relatively high composite pigment content may be comprised in the composition in order to obtain the desired covering power and, such as, a relatively high covering power.

A suitable tint may be obtained in a variety of manners, for example by mixing the composite pigments of the present disclosure, said pigments having different colors, and/or by at least partially coating the inorganic cores of the composite pigment or pigments with a plurality of organic coloring substances, said organic coloring substances being mixed or being in respective layers of the coating.

As used herein, the term “at least partially coated” is understood to mean coating all or a portion of the inorganic core.

The composition of the present disclosure may further comprise a physiologically acceptable medium. As used herein, the term “physiologically acceptable medium” is understood to mean a non-toxic medium that can be applied to the skin, to the lips, to the nails, or to hair of human beings, such as a cosmetic medium. The physiologically acceptable medium can be adapted to the nature of the surface onto which the composition is to be applied, and to the form in which the composition is intended to be packaged, for instance, a solid or a fluid at ambient temperature and atmospheric pressure.

As used herein, the term “cosmetic composition” is understood to mean a composition as defined in Council Directive 93/35/EEC dated 14 Jun. 1993.

When evaluating a liquid or pasty composition, a sample of the composition to be studied is introduced into a small metal cup that is about 1 centimeter (cm) deep. A blade of quartz that is 1 millimeter (mm) thick is pressed against the composition, taking care to avoid air bubbles before taking the measurement.

When evaluating a composition in powder form, the powder sample is compacted at a pressure of 10 megapascals (MPa) in a small metal cup that is about 1 cm deep. A blade of quartz that is 1 mm thick is pressed against the composition before taking the measurement.

When evaluating a stick composition, the formulation is initially ground down so as to obtain a viscous paste. The composition is then poured into a mold made of quartz that that has a flat bottom and is about 2 cm deep.

The L*, a*, b* chromaticity coordinates of the composition in the CIE L*a*b* space are measured with a MINOLTA CM-508d spectrocolorimeter, under a D65 illuminant, with a specular component included and a d/8 lighting system.

The saturation C* of the composition is calculated by means of the formula C*=[(a*)²+(b*)²]^{1/2}.

For a powder, 50 parts by weight of the powder are ground down with 50 parts by weight of dimethicon (DOW CORNING DC 200 Fluid 5CST) so as to obtain a viscous paste.

To evaluate the covering power, the composition sample is spread to a thickness of 30 micrometers (μm) on an Erichsen contrast card, type 24/5, that presents a black background and a white background, and the (X, Y, Z) chromaticity coordinates are measured by means of a CR-300 colorimeter. The composition is similarly spread on other contrast cards and three measurements are taken for each card. The average of these nine measurements is then calculated.

The covering power is equal to 100×Yn/Yb, where Yn is the average value of Y on a black background and Yb is the average value of Y on a white background. A covering power of 100 corresponds to a formulation that is completely opaque. The at least one composite pigment of the present disclosure can comprise particles comprising an inorganic core, which is at least partially coated with at least one organic coloring substance.

The at least one organic coloring substance can be present in the composition in a total amount less than or equal to 10%, relative to the total weight of the composition.

In one embodiment of the present disclosure, the at least one composite pigment is not an interference pigment. As used herein, the term “interference pigment” is understood to mean, for example, a pigment comprising a superposition of layers of constant thickness of materials selected to produce optical interferences. An example of an interference pigment is disclosed in U.S. Pat. No. 6,428,773.

In another embodiment of the present disclosure, the at least one organic coloring substance is not melanin.

The saturation C* of the at least one composite pigment may be greater than or equal to 30, measured according to the following protocol.

Protocol for Measuring the Saturation C* of the Composite Pigment:

The color values a* and b* in the CIE L*a*b* colorspace of the composite pigment are measured as follows.

The composite pigment in a raw state is compacted in a rectangular cup having dimensions of 2×1.5 cm and a depth of 3 mm, by applying a pressure of 100 bars. The a* and b* values of the compacted pigment are measured with a Minolta 3700d spectrophotometer, in mode specular excluded, under illuminant D65 and medium aperture. The saturation is computed as C*=(a*²+b*²)^{1/2}.

The compositions may further comprise at least one binder, which may, for example, contribute to fixing the at least one organic coloring substance onto the inorganic core.

The particles of the at least one composite pigment may have a variety of forms. For example, said particles may be in the form of flakes or they may be globular, such as spherical, and may be hollow or solid. As used herein, the term “in the form of flakes” is understood to mean particles for which the ratio of the largest dimension to the thickness is greater than or equal to 5.

The at least one composite pigment of the present disclosure can, for example, have a specific surface area ranging from 1 m²/g (square meters/gram) to 1,000 m²/g, for instance, ranging from 10 m²/g to 600 m²/g, such as ranging from 20 m²/g to 400 m²/g. The specific surface area is the value measured using the BET (Brunauer-Emmett-Teller) method.

The compositions may comprise at least one composite pigment solely of the kind defined above or, in another aspect of the present disclosure, it can comprise at least one other composite pigment, as well as at least one pigment having a non-composite structure, such as mineral pigments, interference pigments, lakes, or organic pigments. In one embodiment of the present disclosure, the composition does not comprise uncoated TiO₂ particles.

The inorganic core may have any form that is suitable for fixing particles of organic coloring substance. Among the forms the inorganic core may be in, non-limiting mention may be made of, for example, spherical, globular, granular, polyhedral, acicular, spindle-shaped, flattened in the form of a flake, a rice grain, or a scale form, and combinations thereof.

In one embodiment of the present disclosure, the ratio of the largest dimension of the core to its smallest dimension ranges from 1 to 50.

The inorganic core can have a mean size ranging from 1 nm (nanometer) to 100 nm, such as ranging from 5 nm to 75 nm, for example ranging from 10 nm to 50 nm. As used herein, the term “mean size” is understood to mean the dimension given by the statistical grain size distribution curve at 50% population, termed D50. The mean size may be a number average determined by image analysis (electron microscopy).

The inorganic core can have a refractive index of greater than or equal to 2, such as greater than or equal to 2.1, for example greater than or equal to 2.2.

The inorganic core can be formed, by way of non-limiting example, from at least one material chosen from metallic salts and metal oxides, such as oxides of titanium, zirconium, cerium, zinc, iron, iron blue, aluminum, and chromium, aluminas, glasses, ceramics, graphite, silicas, silicates, for instance aluminosilicates and borosilicates, and synthetic mica.

For example, oxides of titanium, such as TiO₂, of iron, such as Fe₂O₃, of cerium, zinc, and aluminum, silicas and silicates, for instance aluminosilicates and borosilicates, can be used.

The inorganic core can have a specific surface area, measured using the BET method, ranging from 1 m²/g to 1,000 m²/g, for instance, ranging from 10 m²/g to 600 m²/g, for example ranging from 20 m²/g to 400 m²/g.

The inorganic core can be colored if desired.

The inorganic core in the at least one composite pigment can be present in an amount greater than or equal to 50% by weight, relative to the total weight of the at least one composite pigment, for example ranging from 50% to 70%, such as from 60 to 70% by weight, relative to the total weight of the composition.

The at least one organic coloring substance can, for example, comprise at least one organic pigment/lake.

The at least one organic coloring substance can, for example, be chosen from certain compounds that are insoluble in the physiologically acceptable medium of the composition.

The organic coloring substance can, for example, comprise at least one pigment/organic lakes chosen from

cochineal carmine;

the organic pigments of azo, anthraquinone, indigo, xanthene, pyrene, quinoline, triphenylmethane, and fluorane dyes;

organic lakes and/or organic insoluble salts of sodium, potassium, calcium, barium, aluminum, zirconium, strontium, titanium, and of acid dyes such as azo, anthraquinone, indigo, xanthene, pyrene, quinoline, triphenylmethane, and fluorine dyes, which dyes can comprise at least one carboxylic or sulfonic acid group.

By way of non-limiting example, organic pigments that may be mentioned include D&C Blue No. 4, D&C Brown No. 1, D&C Green No. 5, D&C Green No. 6, D&C Orange No. 4, D&C Orange No. 5, D&C Orange No. 10, D&C Orange No. 11, D&C Red No. 6, D&C Red No. 7, D&C Red No. 17, D&C Red No. 21, D&C Red No. 22, D&C Red No. 27, D&C Red No. 28, D&C Red No. 30, D&C Red No. 31, D&C Red No. 33, D&C Red No. 34, D&C Red No. 36, D&C Violet No. 2, D&C Yellow No. 7, D&C Yellow No. 8, D&C Yellow No. 10, D&C Yellow No. 11, FD&C Blue No. 1, FD&C Green No. 3, FD&C Red No. 40, FD&C Yellow No. 5, FD&C Yellow No. 6, and organic lakes supported by an organic support such as colophane or aluminum benzoate, for example.

By way of non-limiting example, the organic lakes that may be mentioned include D&C Red No. 2 Aluminum lake, D&C Red No. 3 Aluminum lake, D&C Red No. 4 Aluminum lake, D&C Red No. 6 Aluminum lake, D&C Red No. 6 Barium lake, D&C Red No. 6 Barium/Strontium lake, D&C Red No. 6 Strontium lake, D&C Red No. 6 Potassium lake, D&C Red No. 7 Aluminum lake, D&C Red No. 7 Barium lake, D&C Red No. 7 Calcium lake, D&C Red No. 7 Calcium/Strontium lake, D&C Red No. 7 Zirconium lake, D&C Red No. 8 Sodium lake, D&C Red No. 9 Aluminum lake, D&C Red No. 9 Barium lake, D&C Red No. 9 Barium/Strontium lake, D&C Red No. 9 Zirconium lake, D&C Red No. 10 Sodium lake, D&C Red No. 19 Aluminum lake, D&C Red No. 19 Barium lake, D&C Red No. 19 Zirconium lake, D&C Red No. 21 Aluminum lake, D&C Red No. 21 Zirconium lake, D&C Red No. 22 Aluminum lake, D&C Red No. 27 Aluminum lake, D&C Red No. 27 Aluminum/Titanium/Zirconium lake, D&C Red No. 27 Barium lake, D&C Red No. 27 Calcium lake, D&C Red No. 27 Zirconium lake, D&C Red No. 28 Aluminum lake, D&C Red No. 30 lake, D&C Red No. 31 Calcium lake, D&C Red No. 33 Aluminum lake, D&C Red No. 34 Calcium lake, D&C Red No. 36 lake, D&C Red No. 40 Aluminum lake, D&C Blue No. 1 Aluminum lake, D&C Green No. 3 Aluminum lake, D&C Orange No. 4 Aluminum lake, D&C Orange No. 5 Aluminum lake, D&C Orange No. 5 Zirconium lake, D&C Orange No. 10 Aluminum lake, D&C Orange No. 17 Barium lake, D&C Yellow No. 5 Aluminum lake, D&C Yellow No. 5 Zirconium lake, D&C Yellow No. 6 Aluminum lake, D&C Yellow No. 7 Zirconium lake, D&C Yellow No. 10 Aluminum lake, FD&C Blue No. 1 Aluminum lake, FD&C Red No. 4 Aluminum lake, FD&C Red No. 40 Aluminum lake, FD&C Yellow No. 5 Aluminum lake, and FD&C Yellow No. 6 Aluminum lake.

The chemical compounds corresponding to each of the organic coloring substances listed above are mentioned in the work entitled Intemational Cosmetic Ingredient Dictionary and Handbook, 1997 edition, pages 371 to 386 and 524 to 528, published by “The Cosmetic, Toiletry, and Fragrance Association,” the contents of which are hereby incorporated by reference.

The at least one organic coloring substance can be present in an amount ranging from 10 parts to 500 parts by weight per 100 parts of inorganic core, such as ranging from 20 parts to 250 parts by weight, for example ranging from 40 parts to 125 parts by weight per 100 parts of inorganic core.

The at least one organic coloring substance in the at least one composite pigment can be present in an amount greater than or equal to 30% by weight, relative to the total weight of the at least one composite pigment, for example ranging from 30% to 50%, such as from 30% to 40% by weight, relative to the total weight of the at least one composite pigment.

The at least one binder can be of any type on the condition that it allows the at least one organic coloring substance to adhere to the surface of the inorganic core. By way of non-limiting example, the at least one binder can be chosen from silicone compounds, polymeric, oligomeric and similar compounds, such as organosilanes, fluoroalkylated organosilanes and polysiloxanes, for example polymethylhydrogen siloxane, as well as to variety of coupling agents such as coupling agents based on silanes, titanates, aluminates, and zirconates.

Among the at least one silicone compound that can be used, non-limiting mention may be made of:
organosilanes (1) obtained from alkoxysilanes;
polysiloxanes (2) which may optionally be modified, non-limiting examples of which include:
   modified polysiloxanes (2A) comprising at least one radical chosen for example, from polyethers, polyesters and epoxy compounds (termed “modified polysiloxanes” below);
   polysiloxanes (2B) carrying, on one silicon atom located at the end of the polymer, at least one group chosen for instance from: carboxylic acids, alcohols, and hydroxyl groups; and
   fluoroalkylated organosilane compounds (3) obtained from fluoroalkylsilanes.

The organosilane compounds (1) can be obtained from alkoxysilane compounds of formula (I):
R¹ₐSiX₄₋ₐ (I)
wherein:
R¹ is chosen from C₆H₅—, (CH₃)₂CH—CH₂— and C_{b}H_{2b+1}— type radicals (in which b ranges from 1 to 18);
X is chosen from CH₃O— and C₂H₅O— radicals; and
a ranges from 0 to 3.

Among the alkoxysilane compounds that may be used according to the present disclosure, non-limiting mention may be made of methyltriethoxysilane, dimethyldiethoxysilane, phenyltriethoxysilane, diphenyldiethoxysilane, methyltrimethoxysilane, dimethyidimethoxysilane, phenyltrimethoxysilane, diphenyldimethoxysilane, isobutyltrimethoxysilane, and decyltrimethoxysilane. For instance, the at least one alkoxysilane may be chosen from methyltriethoxysilane, phenyltriethoxysilane, methyltrimethoxysilane, dimethyldimethoxysilane, isobutyltrimethoxysilane. In one embodiment of the present disclosure, the at least one alkoxysilane may be chosen from methyltriethoxysilane, methyltrimethoxysilane, and phenyltriethoxysilane.

The polysiloxanes (2) can be chosen from those of formula (II):

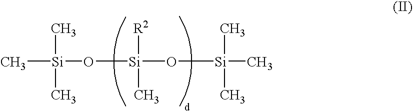

wherein R² is chosen from hydrogen atoms and CH₃— groups, and d ranges from 15 to 450.

In one embodiment of the present disclosure, R² is chosen from hydrogen atoms.

The modified polysiloxanes (2A) can be chosen from

(a¹) modified polysiloxanes carrying polyethers, chosen from those of formula (III): 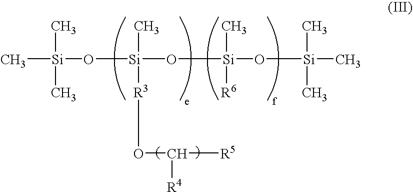
wherein R³ is chosen from —(CH₂)ₕ— radicals; R⁴ is chosen from —(CH₂)ᵢ—CH₃ radicals; R⁵ is chosen from —OH, —COOH, —CH═CH₂, —C(CH₃)═CH₂ and —(CH₂)ⱼ—CH₃ radicals; R⁶ is chosen from —(CH2)ₖ—CH₃ radicals; g and h, independently of each other, range from 1 to 15; j and k, independently of each other, range from 0 to 15; e ranges from 1 to 50, and f ranges from 1 to 300;
(a²) modified polysiloxanes carrying polyesters, chosen from those of formula (IV): 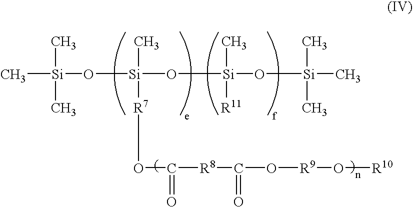
wherein R⁷, R⁸, and R⁹, which may be identical or different, can be chosen from —(CH₂)_{q}— radicals; R¹⁰ is chosen from —OH, —COOH, —CH═CH₂, —C(CH₃)═CH₂ and —(CH₂)ᵣ—CH₃ radicals; R¹¹ is chosen from —(CH₂)ₛ—CH₃ radicals; n and q, independently of each other, range from 1 to 15, r and s, independently of each other, range from 0 to 15; e ranges from 1 to 50, and f ranges from 1 to 300 ; and
(a³) modified polysiloxanes carrying epoxy radicals chosen from those of formula (V): 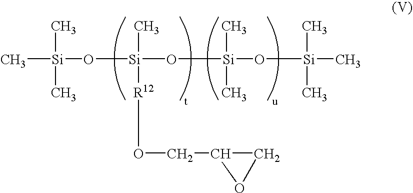
wherein R¹² is chosen from —(CH₂)ᵥ— radicals; v ranges from 1 to 15; t ranges from 1 to 50, and u ranges from 1 to 300.

In one embodiment of the present disclosure, the polysiloxanes (2A) are chosen from modified polysiloxanes carrying polyethers with formula (III).

The polysiloxanes modified at the terminal portion (2B) can be chosen from those of formula (VI): 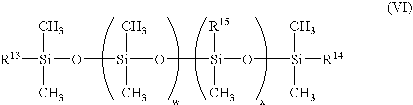
wherein R¹³ and R¹⁴, which may be identical or different, are chosen from —OH, R¹⁶—OH, and R¹⁷—COOH radicals; R¹⁵ is chosen from —CH₃ and —C₆H₅ radicals; R¹⁶ and R¹⁷ are chosen from —(CH₂)_{y}— radicals; y ranges from 1 to 15; w ranges from 1 to 200; and x ranges from 0 to 100.

In one embodiment of the present disclosure, the polysiloxanes modified on at least one end are chosen from those carrying at least one radical (R¹⁶ and/or R¹⁷) comprising a carboxylic acid group on at least one terminal silicon atom.

The fluoroalkylated organosilane compounds (3) can be chosen from fluoroalkylsilanes of formula (VII):
CF₃(CF₂)_{z}CH₂CH₂(R¹⁸)ₐSiX₄₋ₐ (VII)
wherein:
R¹⁸ is chosen from CH₃—, C₂H₅—, CH₃O—, and C₂H₅O— radicals;
X is chosen from CH₃O— and C₂H₅O— radicals;
z ranges from 0 to 15 and a ranges from 0 to 3.

Among the fluoroalkylsilanes that may be used, non-limiting mention may be made of trifluoropropyltrimethoxysilane, tridecafluorooctyltrimethoxysilane, heptadecafluorodecyltrimethoxysilane, heptadecafluorodecylmethyldimethoxysilane, trifluoropropyltriethoxysilane, tridecafluorooctyltriethoxysilane, heptadecafluorodecyltriethoxysilane, heptadecafluorodecylmethyldiethoxysilane and the like. In one embodiment of the present disclosure, the fluoroalkylsilanes are chosen from trifluoropropyltrimethoxysilane, tridecafluorooctyltrimethoxysilane and heptadecafluorodecyltrimethoxysilane, and in another embodiment, the fluoroalkylsilanes may be chosen from trifluoropropyl trimethoxysilane and tridecafluorooctyltrimethoxysilane.

Non-limiting examples of the silane-based coupling agentsinclude vinyltrimethoxysilane, vinyltriethoxysilane, γ-aminopropyl-triethoxysilane, γ-glycidoxypropyltrimethoxysilane, γ-mercaptopropyltrimethoxysilane, γ-methacryloxypropyltrimethoxysilane, N-β(aminoethyl)-γ-aminopropyltrimethoxysilane, γ-glycidoxypropylmethyldimethoxysilane, and γ-chloropropyltrimethoxysilane.

Non-limiting examples of the titanate-based coupling agents include isopropylstearoyl titanate, isopropyltris(dioctylpyrophosphate) titanate, isopropyltri(N-aminoethyl-aminoethyl) titanate, tetraoctylbis(ditridecylphosphate) titanate, tetra(2,2-diaryloxymethyl-1-butyl)bis(ditridecyl)phosphate titanate, bis(dioctylpyrophosphate)oxyacetate titanate, and bis(dioctylpyrophosphate)ethylene titanate.

Non-limting examples of the aluminate-based coupling agents include acetoalkoxyaluminum diisopropylate, aluminum diisopropoxymonoethylacetoacetate, aluminum trisethylacetoacetate, and aluminum trisacetylacetonate.

Non-limiting examples of the zirconate-based coupling agents include zirconium tetrakisacetylacetonate, zirconium dibutoxybisacetylacetonate, zirconium tetrakisethylacetoacetate, zirconium tributoxymonoethylacetoacetate, and zirconium tributoxyacetylacetonate.

The compounds acting as the at least one binder can have a molar mass ranging from 300 to 100,000.

To obtain a layer which uniformly coats the inorganic cores, the binder may be, for example, in the liquid state or can be soluble in water or other solvents.

The at least one binder can be present in an amount ranging from 0.01% to 15%, such as from 0.02% to 12.5%, for example, from 0.03% to 10% by weight (calculated with respect to C or Si) relative to the weight of particles comprising the core and the binder. Further details regarding the calculation of the relative quantity of binder can be found in European Patent Application No. EP 1 184 426 A2.

The at least one binder may or may not be used.

The at least one composite pigment may be manufactured by any appropriate method, for example a mechano-chemical method or a method of precipitation in solution, with dissolution of an organic coloring substance and a precipitation thereof at the surface of the core.

For example, a method comprising a mechanical mixing of an organic pigment and the inorganic core may be used. At least one binder may be optionally added and mixed with the inorganic core before the introduction of the organic coloring substance.

The at least one composite pigment can, for example, be produced using one of the processes described in European Patent Application Nos. EP 1 184 426 and EP 1 217 046, the contents of which are hereby incorporated by reference. In one embodiment of the present disclosure, the at least one composite pigment is produced by the process described in European Patent Application No. EP 1 184 426.

In another embodiment of the present disclosure, the particles intended to constitute the inorganic core are first mixed with at least one binder.

So that the binder can adhere uniformly to the surface of the inorganic core, the particles, for example, can pass initially through a mill to disaggregate them. The mixing and agitation conditions are selected so that the core is uniformly coated with binder. Such conditions can be controlled so that the linear load ranges from 19.6 N/cm (newtons/centimeter) to 19,160 N/cm, for instance, in ranging from 98 N/cm to 14,170 N/cm, such as ranging from 147 N/cm to 980 N/cm; the period of treatment time ranges from 5 minutes to 24 hours, for example, ranging from 10 minutes to 20 hours; the rotation rate can range from 2 rpm (revolutions per minute) to 1,000 rpm, such as from 5 rpm to 1,000 rpm, and for example, from 10 rpm to 800 rpm.

After coating the inorganic core with at least one binder, the at least one organic coloring substance is added and mixed with agitation so that it adheres to the layer of binder.

Examples of addition methods that may be used include continuous addition in large quantities, or in small quantities.

Mixing and agitation, whether of the inorganic cores with the at least one binder, or of the at least one organic coloring substance with the inorganic cores coated with binder, may be carried out using an apparatus which can apply a sharp shearing and/or compressive force to the mixture of powders. Non-limiting examples of apparatus of that type include roller mixers and blade mixers. In one embodiment of the present disclosure, a roller mixer is used. A list of suitable apparatus is given in European Patent Application No. EP 1 184 426 A2.

An additional method for manufacturing a composite pigment has been described in Japanese Patent No. JP 3286463, which discloses a solution precipitation process. The at least one organic coloring substance is dissolved in ethanol and the inorganic cores are then dispersed in said ethanolic solution. An aqueous alkaline solution of sodium or potassium carbonate is then slowly added to these mixtures and finally, an ethanolic calcium chloride solution is slowly added, with constant agitation.

The composition can further comprise at least one aqueous and/or organic solvent.

When the composition comprises at least one organic solvent, the solvent can be present in an amount ranging from 0.1% to 99% by weight, relative to the total composition weight.

In general, the amount of the at least one solvent, such as at least one organic solvent, will depend on the nature of the surface onto which the composition is intended to be applied.

In the case of a nail polish, for example, the at least one organic solvent can be present in the composition in an amount ranging from 30% to 99% by weight, such as from 60% to 90% by weight, for example, relative to the total composition weight.

The composition can further comprise at least one organic solvent chosen from:

ketones that are liquid at ambient temperature, such as methylethylketone, methylisobutylketone, diisobutylketone, isophorone, cyclohexanone, and acetone;

alcohols that are liquid at ambient temperature, such as ethanol, isopropanol, diacetone alcohol, 2-butoxyethanol, and cyclohexanol;

glycols that are liquid at ambient temperature, such as ethylene glycol, propylene glycol, pentylene glycol and glycerol;

propylene glycol ethers that are liquid at ambient temperature, such as propylene glycol monomethyl ether, the acetate of propylene glycol monomethyl ether, and dipropylene glycol mono n-butyl ether;

short chain esters (comprising a total of 3 to 8 carbon atoms), such as ethyl acetate, methyl acetate, propyl acetate, n-butyl acetate, and isopentyl acetate; and

alkanes that are liquid at ambient temperature, such as decane, heptane, dodecane, and cyclohexane.

The composition can also comprise water or a mixture of water and at least one hydrophilic organic solvent that are routinely used in cosmetics, such as alcohols, for instance linear and branched lower monoalcohols comprising from 2 to 5 carbon atoms, such as ethanol, isopropanol or n-propanol, polyols such as glycerine, diglycerine, propylene glycol, sorbitol, penthylene glycol, or polyethylene glycols. The composition can also comprise hydrophilic C₂ ethers and C₂-C₄ aldehydes. The water or mixture of water and at least one hydrophilic organic solvent can be present in the composition in an amount ranging from 0% to 90%, for instance from 0.1% to 90% by weight, such as from 0% to 60% by weight, for example, from 0.1% to 60% by weight, relative to the total composition weight.

For example, when it is to be applied to the lips, the composition can further comprise at least one oily phase, for instance, at least one fat that is liquid at ambient temperature (25° C.) and/or at least one fat that is solid at ambient temperature, such as waxes, pasty fats, gums, and mixtures thereof. The oily phase can further comprise lipophilic organic solvents.

The composition may, for example, comprise a continuous oily phase that can comprise less than 5% water, such as less than 1% water relative to its total weight. In one embodiment of the present disclosure, the composition is in anhydrous form.

Among the fats that are liquid at ambient temperature, also called “oils,” that may be used, non-limiting mention may be made of: hydrocarbon-comprising vegetable oils such as liquid fatty acid triglycerides comprising from 4 to 10 carbon atoms, for example heptanoic or octanoic acid triglycerides, or sunflower, corn, soybean, grapeseed, sesame seed, apricot kernel, macadamia nut, castor, or avocado stone oil, caprylic/capric acid triglycerides, jojoba oil, shea nut butter oil, lanolin, acetylated lanolin; linear or branched hydrocarbons of mineral or synthetic origin, such as paraffin oils and their derivatives, petroleum jelly, polydecenes, hydrogenated polyisobutene such as Parleam; synthesized esters and ethers, for instance, fatty acids such as Purcellin oil, isopropyl myristate, 2-ethylhexyl palmitate, 2-octyldodecyl stearate, 2-octyldodecyl erucate, isostearyl isostearate; hydroxylated esters such as isostearyl lactate, octylhydroxystearate, octyidodecyl hydroxystearate, diisostearylmalate, triisocetyl citrate, fatty alcohol heptanoates, octanoates or decanoates; isononyl isonanoate, isopropyl lanolate, tridecyl trimellilate, diisostearyl malate; polyol esters such as propylene glycol dioctanoate, neopentylglycol diheptanoate, diethyleneglycol diisononanoate; and pentaerythritol esters; fatty alcohols comprising from 12 to 26 carbon atoms, such as octyidodecanol, 2-butyloctanol, 2-hexyldecanol, 2-undecylpentadecanol or oleic alcohol; partially hydrocarbonated and/or siliconized fluorinated oils; silicone oils such as volatile or non volatile, linear or cyclic polymethylsiloxanes (PDMS) which may be liquid or pasty at ambient temperature, such as cyclomethicones or dimethicones, optionally comprising a phenyl group, such as phenyl trimethicones, phenyltrimethylsiloxydiphenyl siloxanes, diphenylmethyldimethyl-trisiloxanes, diphenyl dimethicones, phenyl dimethicones, polymethylphenylsiloxanes; and mixtures thereof. The at least one oil may be present in an amount ranging from 0.01% to 90%, such as 0.1% to 85% by weight, relative to the total composition weight.

Pasty fats are generally hydrocarbon-comprising compounds with a melting point ranging from 25° C. to 60° C., for instance ranging from 30° C. to 45° C. and/or with hardness ranging from 0.001 MPa (megapascals) to 0.5 MPa, for instance ranging from 0.005 MPa to 0.4 MPa, such as lanolins and derivatives thereof.

Waxes can be solid at ambient temperature (25° C.) with a reversible solid/liquid change of state, with a melting point ranging from 30° C. to 200° C., a hardness of greater than 0.5 MPa, and with an anisotropic crystalline organization in the solid state. For example, the waxes may have a melting point of greater than 25° C., such as greater than or equal to 45° C. The at least one wax can be hydrocarbon-comprising, fluorinated and/or siliconized and can be of animal, mineral, vegetable and/or synthetic origin. Among the waxes that may be used, non-limiting mention may be made of beeswax, camauba wax or candellila wax, paraffin, microcrystalline waxes, ceresin, or ozokerite; synthetic waxes such as polyethylene or Fischer-Tropsch waxes or silicone waxes such as alkyl or alkoxy-dimethicone comprising from 16 to 45 carbon atoms. The at least one wax, may be present in an amount ranging from 0% to 50% by weight, relative to the total composition weight, such as from 1% to 30% by weight.

Suitable gums that may be used include high molecular weight polydimethylsiloxanes (PDMS), cellulose gums or polysaccharides.

The composition may also, for example, comprise at least one film-forming polymer, such as for a mascara or a nail polish. As used herein, the term “film-forming polymer” is understood to mean a polymer that can form, by itself or in the presence of an additional film-forming agent, a continuous film that adheres to a surface, for instance to keratinous materials.

Among the film-forming polymers that may be used in a composition in accordance with the present disclosure, non-limiting mention may be made of synthetic polymers, of the radical or polycondensate type, natural polymers such as nitrocellulose or cellulose esters, and mixtures thereof.

Non-limiting examples of radical type film-forming polymers include vinyl polymers or copolymers, such as acrylic polymers.

Vinyl film-forming polymers can result from polymerizing monomers with an ethylenically unsaturated bond comprising at least one acid group and/or esters of said acid monomers and/or amides of said acid monomers, such as a, β-ethylenically unsaturated carboxylic acids, for example acrylic acid, methacrylic acid, crotonic acid, maleic acid, or itaconic acid.

Vinyl film-forming polymers can also result from homopolymerizing or copolymerizing monomers chosen from vinyl esters such as vinyl acetate, vinyl neodecanoate, vinyl pivalate, vinyl benzoate, and vinyl t-butyl benzoate, and styrene monomers such as styrene and alpha-methyl styrene.

Non-limiting examples of film-forming polycondensates that may be mentioned include polyurethanes, polyesters, polyester amides, polyamides, and polyureas.

Polymers of natural origin, which may optionally be modified, can be chosen from shellac resin, gum sandarac, dammar resin, gum elemi, copal resin, cellulose polymers such as nitrocellulose, ethylcellulose, or nitrocellulose esterschosen, for example, from cellulose acetate, cellulose acetobutyrate, and cellulose acetopropionate, and mixtures thereof.

The at least one film-forming polymer can be present in the form of solid particles in an aqueous or oily dispersion, generally known as latexes or psuedolatexes. The at least one film-forming polymer may comprise at least one stable dispersion of generally spherical polymer particles of at least one polymer in a physiologically acceptable liquid oily phase. Such dispersions are generally termed polymer NADs (non aqueous dispersions), in contrast to latexes which are aqueous polymer dispersions. Such dispersions can be in the form of nanoparticles of polymers in stable dispersion in said oily phase. The nanoparticle size can range, for example, from 5 nm to 600 nm. Techniques for preparing such dispersions are well known to the skilled person.

Among the aqueous film-forming polymer dispersions which may be used, non-limiting mention may be made of acrylic dispersions sold under the trade names NEOCRYL XK-90®, NEOCRYL A-1070®, NEOCRYL A-1090®, NEOCRYL BT-62®, NEOCRYL A-1079®, NEOCRYL A-523® by AVECIA-NEORESINS, and DOW LATEX 432® by DOW CHEMICAL; DAITOSOL 5000 AD® by DAITO KASEI KOGYO; aqueous polyurethane dispersions sold under the trade names NEOREZ R-981® and NEOREZ R-974® by AVECIA-NEORESINS; AVALURE UR-405®, AVALURE UR-410®, AVALURE UR-425®, AVALURE UR-450®, SANCURE 875®, SANCURE 861®, SANCURE 878®, and SANCURE 2060® by GOODRICH; IMPRANIL 85® by BAYER; AQUAMERE H-1511® by HYDROMER; and sulfopolyesters sold under the trade mark Eastman AQ by Eastman Chemical Products.

The compositions of the present disclosure may also comprise at least one auxiliary film-forming agent which encourages the formation of a film with the at least one film-forming polymer.

The composition may also comprise at least one filler. As used herein, the term “fillers” is understood to mean particles of any form which are insoluble in the composition medium regardless of the temperature at which the composition is manufactured. Fillers primarily act to modify the rheology or texture of the composition. The nature and quantity of the at least one filler will be a function of the desired mechanical properties and textures of the end composition.

Non-limiting examples of fillers that may be mentioned include talc, mica, silica, kaolin, and sericite, and powders of polyamide, polyethylene, polytetrafluoroethylene, polymethylmethacrylate, or polyurethane, powdered starch, and silicone resin beads.

The composition may comprise at least one additional coloring substance that differs from the at least one composite pigment defined above. The at least one additional coloring substance can be selected from mineral pigments, organic pigments, nacres, liposoluble colorants and hydrosoluble colorants.

The mineral pigments may be white or colored, and may optionally be coated. Among the mineral pigments that may be used, non-limiting mention may be made of titanium dioxide, which may be surface treated; oxides of zirconium or cerium; and oxides of iron or of chromium; manganese violet; ultramarine blue; chromium hydrate; and iron blue. The mineral pigments may be present in an amount ranging from 0% to 40%, for instance, from 1% to 35%, and such as from 2% to 25% of the total composition weight.

The pearlescent pigments may be chosen from white pearlescent pigments such as mica coated with titanium, or bismuth oxychloride, colored pearlescent pigments, such as titanium mica with iron oxides, titanium mica with, for example, iron blue or chromium oxide, titanium mica with an organic pigment of the above-mentioned type, as well as the bismuth oxychloride-based pearlescent pigments. The pearlescent pigments may be present in an amount ranging from 0% to 20% by weight, relative to the total weight of the composition and, such as from 0.1% to 15% (if present).

Non-limiting examples of organic pigments that may be mentioned include carbon black, D&C type pigments, and lakes based on carmine cochineal, barium, strontium, calcium, or aluminum.

Non-limiting examples of liposoluble colorants include Sudan red, D&C Red No. 17, D&C Green No. 6, β-carotene, soybean oil, Sudan brown, D&C Yellow No. 11, D&C Violet No. 2, D&C orange No. 5, and quinoline yellow.

Non-limiting examples of hydrosoluble colorants include beetroot juice and methylene blue.

The colorants, when present, can be present in an amount ranging from 0.1% to 20% by weight, relative to the total weight of the composition, such as from 0.1% to 6%.

The composition may further comprise at least one cosmetic and/or dermatological active ingredient. Among the suitable cosmetic, dermatological, hygienic, and/or pharmaceutical active ingredients for use in the compositions of the present disclosure, non-limiting mention may be made of moisturizing agents (polyols such as glycerine), vitamins (C, A, E, F, B, or PP), essential fatty acids, essential oils, ceramides, sphingolipids, liposoluble or nanoparticle sun screens, and specific skin treatment active ingredients (protective agents, antibacterials, anti-wrinkle agents, etc). The at least one active ingredient may, for example, be present in an amount ranging from 0% to 20% by weight, such as from 0.001% to 15% by weight, relative to the total composition weight.

The composition may also comprise at least one ingredient that is routinely used in cosmetics, such as thickeners, surfactants, oligo-elements, moisturizing agents, softeners, sequestrating agents, fragrances, alkalinizing or acidifying agents, preservatives, antioxidants, UV filters, colorants, or mixtures thereof.

Depending on the envisaged application, the composition of the present disclosure may further comprise constituents which are conventionally used in the fields under consideration, and which are present in quantities appropriate to the desired dosage or “galenical” form.

The composition may be in a variety of forms, depending on its destination. The composition may thus be in any galenical form which is normally used for topical application, such as in the anhydrous form, in the form of an oily or aqueous solution, an oily or aqueous gel, an oil-in-water emulsion, a water-in-oil emulsion, a wax-in-water or a water-in-wax emulsion, a multiple emulsion or a dispersion of oil in water due to vesicles located on the oil/water interface.

The composition can be in the form of a cast product, for example, a sick in the case of a lipstick or a lip care product.

The composition can also be in a variety of other forms, for example a liquid of greater or lesser viscosity, a gel or a paste.

The composition can also be in solid form, for example a bar to be moistened for use, to allow it to disintegrate.

The composition as disclosed herein can be a makeup composition, including a lipstick, a liquid gloss, a lipstick paste, a blusher, a lip crayon, a solid or fluid foundation, a concealer or eye contour product, an eye liner, a mascara, a nail polish, an eye shadow, a body or hair makeup product, or a sun care product, or skin coloring product.

Another aspect of the present disclosure is a lipstick, which may be liquid or solid, comprising a composition as defined above.

Still another aspect of the present disclosure is a foundation comprising a composition as defined above.

Yet another aspect of the present disclosure is a nail polish comprising a composition as defined above.

Still further another aspect of the present disclosure is a mascara comprising a composition as defined above.

An additional aspect of the present disclosure is also a product for coloring hair fibers and comprising a composition as defined above.

The present disclosure also relates to a process for making up the skin, the lips, the nails, or hair in which a composition as defined above is applied to the skin, the lips, the nails, or hair.

Throughout the description, the term “comprising a” should be understood as being synonymous with “comprising at least one” unless specified to the contrary.

The ranges given include the limit values, unless stated to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific example are reported as precisely as possible. Any numerical value, however, inherently contains certain errors necessarily resulting from the standard deviation found in their respective testing measurements.

The following examples are intended to illustrate the invention in a non-limiting manner.

### EXAMPLES

### Example 1

### Lipstick

A lipstick having the following composition was prepared (quantities given in percentage by weight relative to the total weight of the composition):

| | |
|---|---|
| Polyethylene wax (Polywax 500 from BARECO) | 8.8% |
| Microcrystalline wax (SP 18 from STRAHL & PITSCH) | 4% |
| Palmitic-lauric-stearic acid triglyceride | 5% |
| (Softisan 100 from SASOL) | |
| Octyldodecanol | 14.6% |
| Lanolin oil | 8.9% |
| Acetylated lanolin oil | 8.9% |
| Isopropyl lanolate | 8.9% |
| Tridecyl trimellilate | 9.7% |
| Diisotearyl malate | 12.2% |
| Phenyl trimethicone (DC 556 from DOW CORNING) | 4.0% |
| TiO₂ FD&C Blue Al lake composite pigment¹ | 15% |

¹Composite pigment comprised 50 parts by weight of organic lake known as FD&C Blue 1 Al lake per 100 parts of an inorganic core of titanium dioxide having a mean size of 20 nm and a specific surface area of 50 m2/g and made with a polymethylhydrogen siloxane binder.

### Comparative Example 1

### Lipstick

A lipstick was prepared having the following composition, not in accordance with the present disclosure, with a pure organic lake as its coloring substance (quantities expressed in percentage by weight relative to the total weight of the composition):

| | |
|---|---|
| Polyethylene wax (Polywax 500 from BARECO) | 8.8% |
| Microcrystalline wax (SP 18 from STRAHL & PITSCH) | 4% |
| Palmitic-lauric-stearic acid triglyceride | 5% |
| (Softisan 100 from SASOL) | |
| Octyldodecanol | 14.6% |
| Lanolin oil | 8.9% |
| Acetylated lanolin oil | 8.9% |
| Isopropyl lanolate | 8.9% |
| Tridecyl trimellilate | 9.7% |
| Diisotearyl malate | 12.2% |
| Phenyl trimethicone (DC 556 from DOW CORNING) | 4.0% |
| FD&C Blue 1 Al lake² | 15% |

²An organic lake known as FD&C Blue 1 Al lake.

The compositions of Example 1 and of Comparative Example 1 have the same ingredients in the same proportions, with the exception of the pigments.

The saturation C* values of the compositions of Example 1 and of Comparative Example 1 were measured. The color difference ΔE relative to a pure pigment in compacted powder form was also measured.

| | Example 1 | Comparative Example 1 |
|---|---|---|
| Saturation C* | 32.9 | 4.5 |
| ΔE/pure pigment | 8.9 | 36.2 |

The composition of Example 1 presented high saturation C* and color little different from the color of the pure pigment in compacted powder form, unlike the composition of Comparative Example 1.

### Example 2

### Lipstick

A lipstick was prepared having the following composition (quantities expressed in percentage by weight relative to the total weight of the composition);

| | |
|---|---|
| Polyethylene wax (Polywax 500 from BARECO) | 8.8% |
| Microcrystalline wax (SP 18 from STRAHL & PITSCH) | 4% |
| Palmitic-lauric-stearic acid triglyceride | 5% |
| (Softisan 100 from SASOL) | |
| Octyldodecanol | 16.7% |
| Lanolin oil | 10.3% |
| Acetylated lanolin oil | 10.3% |
| Isopropyl lanolate | 10.3% |
| Tridecyl trimellilate | 11.1% |
| Diisotearyl malate | 14.0% |
| Phenyl trimethicone (DC 556 from DOW CORNING) | 4.5% |
| TiO₂ FD&C Blue Al lake composite pigment¹ | 5% |

¹Composite pigment comprised 50 parts by weight of organic lake known as FD&C Blue 1 Al lake per 100 parts of an inorganic core of titanium dioxide having a mean size of 20 nm and a specific surface area of 50 m²/g and made with a polymethylhydrogen siloxane binder.

### Comparative Example 2

### Lipstick

A lipstick was prepared having the following composition, not in accordance with the present disclosure, with a pure organic lake as its coloring substance (quantities expressed in percentage by weight relative to the total weight of the composition:

| | |
|---|---|
| Polyethylene wax (Polywax 500 from BARECO) | 8.8% |
| Microcrystalline wax (SP 18 from STRAHL & PITSCH) | 4% |
| Palmitic-lauric-stearic acid triglyceride | 5% |
| (Softisan 100 from SASOL) | |
| Octyldodecanol | 16.7% |
| Lanolin oil | 10.3% |
| Acetylated lanolin oil | 10.3% |
| Isopropyl lanolate | 10.3% |
| Tridecyl trimellilate | 11.1% |
| Diisotearyl malate | 14.0% |
| Phenyl trimethicone (DC 556 from DOW CORNING) | 4.5% |
| FD&C Blue 1 Al lake² | 5% |

²An organic lake known as FD&C Blue 1 Al lake.

The compositions of Example 2 and of Comparative Example 2 have the same ingredients in the same proportions, with the exception of the pigments.

The covering powers and the saturations C* of the compositions of Example 2 and of Comparative Example 2 were measured.

| | Example 2 | Comparative Example 2 |
|---|---|---|
| Covering power | 28 | 17 |
| Saturation C* | 31 | 8 |

The covering power and the saturation C* have values that were considerably higher for the composition of Example 2 than for the composition of Comparative Example 2.

### Example 3

### Foundation

A foundation was prepared having the following composition (quantities expressed in percentage by weight relative to the total weight of the composition):

| | |
|---|---|
| Dimethicone copolyol (KF 6017 from SHIN ETSU) | 5% |
| Dimethicone (DC 200 Fluid from DOW CORNING) | 4% |
| Cyclomethicone | 15% |
| Isododecane | 10% |
| Bentone gel (Bentone gel VS5V from ELEMENTIS) | 10% |
| Plastic Powder D400³ | 4% |
| Titanium oxide coated in aluminum glutamate stearoyl⁴ | 6.61% |
| Yellow iron oxide coated in aluminum glutamate stearoyl⁴ | 0.95% |
| Black iron oxide coated in aluminum glutamate stearoyl⁴ | 0.12% |
| TiO₂/D&C Red No. 7 composite pigment⁵ | 0.32% |
| Water | 33.2% |
| Butylene glycol | 10% |
| Magnesium sulfate | 0.8% |

³Sold by TOSHIKI PIGMENT.
⁴Sold by MIYOSHI.
⁵Composite pigment comprising 50 parts by weight of D&C Red No. 7 organic pigment per 100 parts of an inorganic titanium dioxide core of mean size 20 nm and of specific surface area 50 m²/g and made with a polyethylhydrogen siloxane binder.

### Comparative Example 3

### Foundation

A foundation was prepared having the following composition, not in accordance with the present disclosure since it had no composite pigment (quantities expressed in percentage by weight relative to the total weight of the composition):

| | |
|---|---|
| Dimethicone copolyol (KF 6017 from SHIN ETSU) | 5% |
| Dimethicone (DC 200 Fluid from DOW CORNING) | 4% |
| Cyclomethicone | 15% |
| Isododecane | 10% |
| Bentone gel (Bentone gel VS5V from ELEMENTIS) | 10% |
| Plastic Powder D400³ | 4% |
| Titanium oxide coated in aluminum glutamate stearoyl⁴ | 6.61% |
| Yellow iron oxide coated in aluminum glutamate stearoyl⁴ | 0.95% |
| Black iron oxide coated in aluminum glutamate stearoyl⁴ | 0.12% |
| Red iron oxide coated in aluminum glutamate stearoyl⁴ | 0.32% |
| Water | 33.2% |
| Butylene glycol | 10% |
| Magnesium sulfate | 0.8% |

³Sold by TOSHIKI PIGMENT.
⁴Sold by MIYOSHI.

The compositions of Example 3 and of Comparative Example 3 have the same ingredients in the same proportions, apart from the pigments.

The covering powers and the saturation C* of the compositions of Example 3 and of Comparative Example 3 were measured.

| | Example 3 | Comparative Example 3 |
|---|---|---|
| Covering power | 27 | 22 |
| Saturation C* | 71 | 67 |

The covering power and the saturation C* of the composition of Example 3 were better than those of the composition of Comparative Example 3.

1. A composition comprising particles of at least one composite pigment, said particles comprising an inorganic core which is at least partially coated with at least one organic coloring substance,
wherein the at least partially coated inorganic core is present in an amount sufficient for the saturation C* of the composition to range from 25 to 100, and
wherein the composition has a covering power ranging from 25 to 100.

2. The composition according to claim 1, wherein the covering power ranges from 30 to 100.

3. The composition according to claim 1, wherein the covering power ranges from 25 to 90.

4. The composition according to claim 1, wherein the at least one composite pigment has a saturation C* greater than or equal to 30.

5. The composition according to claim 1, wherein the at least one composite pigment comprises the at least partially coated inorganic core in an amount sufficient for the saturation C* of the composition to range from 30 to 100.

6. The composition according to claim 1, wherein the at least one composite pigment is present in the composition in an amount ranging from 0.1% to 30% by weight, relative to the total composition weight.

7. The composition according to claim 6, wherein the at least one composite pigment is present in the composition in an amount ranging from 0.1% to 20% by weight, relative to the total composition weight.

8. The composition according to claim 7, wherein the at least one composite pigment is present in the composition in an amount ranging from 0.1% to 15% by weight, relative to the total composition weight.

9. The composition according to claim 8, wherein the at least one composite pigment is present in the composition in an amount ranging from 0.3% to 10% by weight, relative to the total composition weight.

10. The composition according to claim 9, wherein the at least one composite pigment is present in the composition in an amount ranging from 1% to 5% by weight, relative to the total composition weight.

11. The composition according to claim 1, wherein the at least one organic coloring substance comprises at least one organic pigment.

12. The composition according to claim 1, wherein the mean size of the inorganic core ranges from 1 nm to 100 nm.

13. The composition according to claim 12, wherein the mean size of the inorganic core ranges from 5 nm to 75 nm.

14. The composition according to claim 13, wherein the mean size of the inorganic core ranges from 10 nm to 50 nm.

15. The composition according to claim 1, wherein the inorganic core has a refractive index greater than or equal to 2.

16. The composition according to claim 15, wherein the inorganic core has a refractive index greater than or equal to 2.1.

17. The composition according to claim 16, wherein the inorganic core has a refractive index greater than or equal to 2.2.

18. The composition according to claim 1, wherein the specific surface area of the inorganic core ranges from 1 m²/g to 1000 m²/g.

19. The composition according to claim 18, wherein the specific surface area of the inorganic core ranges from 10 m²/g to 600 m²/g.

20. The composition according to claim 19, wherein the specific surface area of the inorganic core ranges from 20 m²/g to 400 m²/g.

21. The composition according to claim 1, wherein the inorganic core is in a form chosen from spherical, globular, polyhedral, acicular, spindle-shaped, and flattened forms.

22. The composition according to claim 1, wherein the inorganic core comprises at least one material chosen from metallic salts, metal oxides, alumina, glass, ceramics, graphite, silica, silicates, and synthetic micas.

23. The composition according to claim 22, wherein the inorganic core comprises at least one metal oxide chosen from oxides of titanium, zirconium, cerium, zinc, iron, iron blue, chromium, and aluminum.

24. The composition according to claim 23, wherein the at least one metal oxide is chosen from oxides of titanium, iron, cerium, zirconium, zinc, and aluminum.

25. The composition according to claim 24, wherein the inorganic core comprises titanium dioxide.

26. The composition according to claim 22, wherein the inorganic core comprises at least one silicate chosen from aluminosilicate and/or borosilicate.

27. The composition according to claim 22, wherein the inorganic core comprises silica.

28. The composition according to claim 1, wherein the at least one organic coloring substance is present in an amount ranging from 10 to 500 parts by weight per 100 parts by weight of inorganic core.

29. The composition according to claim 28, wherein the at least one organic coloring substance is present in an amount ranging from 20 to 250 parts by weight per 100 parts by weight of inorganic core.

30. The composition according to claim 29, wherein the at least one organic coloring substance is present in an amount ranging from 40 to 125 parts by weight per 100 parts by weight of inorganic core.

31. The composition according to claim 1, wherein the at least one organic coloring substance is present in a total amount less than or equal to 10% by weight, relative to the total weight of the composition.

32. The composition according to claim 11, wherein the at least one organic coloring substance is chosen from carmine cochineal, organic pigments of azo, anthraquinone, indigo, xanthene, pyrene, quinoline, triphenylmethane and fluorane dyes, organic lakes, insoluble sodium, potassium, calcium, barium, aluminum, zirconium, strontium and titanium salts, and acid dyes.

33. The composition according to claim 32, wherein the at least one acid dye is chosen from azo, anthraquinone, indigo, xanthene, pyrene, quinoline, triphenylmethane and fluorane dyes, and other dyes comprising at least one carboxylic or sulfonic acid group.

34. The composition according to claim 32, wherein the at least one organic lake is chosen from those supported by an organic support comprising at least one colophane and/or aluminum benzoate.

35. The composition according to claim 11, wherein the at least one organic coloring substance comprises at least one organic pigment chosen from D&C Blue No. 4, D&C Brown No. 1, D&C Green No. 5, D&C Green No. 6, D&C Orange No. 4, D&C Orange No. 5, D&C Orange No. 10, D&C Orange No. 11, D&C Red No. 6, D&C Red No. 7, D&C Red No. 17, D&C Red No. 21, D&C Red No. 22, D&C Red No. 27, D&C Red No. 28, D&C Red No. 30, D&C Red No. 31, D&C Red No. 33, D&C Red No. 34, D&C Red No. 36, D&C Violet No. 2, D&C Yellow No. 7, D&C Yellow No. 8, D&C Yellow No. 10, D&C Yellow No. 11, FD&C Blue No. 1, FD&C Green No. 3, FD&C Red No. 40, FD&C Yellow No. 5, and FD&C Yellow No. 6.

36. The composition according to claim 35, wherein the at least one organic coloring substance comprises at least one organic lake chosen from D&C Red No. 2 Aluminum lake, D&C Red No. 3 Aluminum lake, D&C Red No. 4 Aluminum lake, D&C Red No. 6 Aluminum lake, D&C Red No. 6 Barium lake, D&C Red No. 6 Barium/Strontium lake, D&C Red No. 6 Strontium lake, D&C Red No. 6 Potassium lake, D&C Red No. 7 Aluminum lake, D&C Red No. 7 Barium lake, D&C Red No. 7 Calcium lake, D&C Red No. 7 Calcium/Strontium lake, D&C Red No. 7 Zirconium lake, D&C Red No. 8 Sodium lake, D&C Red No. 9 Aluminum lake, D&C Red No. 9 Barium lake, D&C Red No. 9 Barium/Strontium lake, D&C Red No. 9 Zirconium lake, D&C Red No. 10 Sodium lake, D&C Red No. 19 Aluminum lake, D&C Red No. 19 Barium lake, D&C Red No. 19 Zirconium lake, D&C Red No. 21 Aluminum lake, D&C Red No. 21 Zirconium lake, D&C Red No. 22 Aluminum lake, D&C Red No. 27 Aluminum lake, D&C Red No. 27 Aluminum/Titanium/Zirconium lake, D&C Red No. 27 Barium lake, D&C Red No. 27 Calcium lake, D&C Red No. 27 Zirconium lake, D&C Red No. 28 Aluminum lake, D&C Red No. 30 lake, D&C Red No. 31 Calcium lake, D&C Red No. 33 Aluminum lake, D&C Red No. 34 Calcium lake, D&C Red No. 36 lake, D&C Red No. 40 Aluminum lake, D&C Blue No. 1 Aluminum lake, D&C Green No. 3 Aluminum lake, D&C Orange No. 4 Aluminum lake, D&C Orange No. 5 Aluminum lake, D&C Orange No. 5 Zirconium lake, D&C Orange No. 10 Aluminum lake, D&C Orange No. 17 Barium lake, D&C Yellow No. 5 Aluminum lake, D&C Yellow No. 5 Zirconium lake, D&C Yellow No. 6 Aluminum lake, D&C Yellow No. 7 Zirconium lake, D&C Yellow No. 10 Aluminum lake, FD&C Blue No. 1 Aluminum lake, FD&C Red No. 4 Aluminum lake, FD&C Red No. 40 Aluminum lake, FD&C Yellow No. 5 Aluminum lake, and FD&C Yellow No. 6 Aluminum lake.

37. The composition according to claim 1, wherein the at least one composite pigment comprises at least one binder contributing to fixing the at least one organic coloring substance on the inorganic core.

38. The composition according to claim 37, wherein the at least one binder comprises at least one compound chosen from silicone compounds, polymeric compounds, oligomeric compounds comprising at least one organosilane, organosilane compounds of fluoroalkylated organosilanes, polysiloxane compounds, and coupling agents.

39. The composition according to claim 38, wherein the at least one coupling agent is based on a silane, a titanate, an aluminate and/or a zirconate.

40. The composition according to claim 38, wherein the at least one binder comprises at least one silicone compound.

41. The composition according to claim 38, wherein the at least one binder comprises polymethylhydrogen siloxane.

42. The composition according to claim 1, wherein the inorganic core is colored.

43. The composition according to claim 1, wherein the composition does not comprise uncoated particles of titanium dioxide.

44. The composition according to claim 1, further comprising at least one cosmetically and/or dermatologically active ingredient.

45. The composition according to claim 1, further comprising at least one additive chosen from fatty bodies, waxes, rubber, and film-forming polymers.

46. The composition according to claim 1, comprising at least one additional coloring substance that is different from the at least one composite pigment.

47. The composition according to claim 46, wherein the at least one additional coloring substance that is different from the at least one composite pigment is chosen from mineral pigments, organic pigments, pearlescent pigments, liposoluble colorings, and hydrosoluble colorings.

48. The composition according to claim 1, wherein the composition is in solid form.

49. The composition according to claim 1, wherein the composition is in liquid, paste, or gel form.

50. The composition according to claim 1, wherein the at least one composite pigment is not an interference pigment.

51. The composition according to claim 1, wherein the at least one organic coloring substance is not melanin.

52. The composition according to claim 37, wherein the at least one binder is present in an amount less than or equal to 5% by weight, relative to the total weight of the at least one composite pigment.

53. The composition according to claim 37, wherein the at least one binder is organic.

54. The composition according to claim 1, wherein the composition is a lipstick.

55. The composition according to claim 1, wherein the composition is a foundation.

56. The composition according to claim 1, wherein the composition is a nail polish.

57. The composition according to claim 1, wherein the composition is a mascara.

58. The composition according to claim 1, wherein the composition is a composition for coloring hair fibers.
